(19) United States
(12) Patent Application Publication
(10) Pub. No.: US 2005/0265488 A1
(43) Pub. Date: Dec. 1, 2005

(54) Apparatus and method for recovery symbol timing in the ofdm system

(76) Inventor: Min-soo Jung, Seoul (KR)

Correspondence Address: CANTOR COLBURN, LLP, 55 GRIFFIN ROAD SOUTH, BLOOMFIELD, CT, 06002, US

(21) Appl. No.: 10/522,482

(22) PCT Filed: Jul. 18, 2003
(86) PCT No.: PCT/KR03/01431

§ 371 Date: Jan. 26, 2005

(30) Foreign Application Priority Data
Jul. 26, 2002 (KR) 10-2002-0044321

(51) Int. Cl. H04L 27/06

(52) U.S. Cl. 375/340

(57) ABSTRACT

An apparatus and method for discriminating an FFT (Fast Fourier Transform) mode and a guard interval mode and detecting the start point of a useful symbol so that a receiver can carry out an FFT operation. The method includes the steps of: detecting a position in which an output value of a sliding integrator is maximal from a path of an observation guard interval selected from a plurality of guard intervals; comparing a value of the position in which the output value of the sliding integrator is maximal with a previous maximum-value position every counting period, producing a difference value between maximum-value positions, accumulating difference values during a predetermined time, producing an average value of the difference values, comparing the average value with a predetermined guard-interval discrimination parameter for the observation guard interval, and discriminating a guard interval mode and an FFT mode according to a result of the comparison; and detecting a position in which an accumulated correlation value is maximal from a path of a discriminated guard interval, adding a value of discriminated guard interval length to a value of the detected position to produce an addition value, and outputting the addition value as information associated with a start point of a useful symbol.

### TECHNICAL FIELD

The present invention relates to a European digital TV transmission system, and more particularly to an apparatus and method for discriminating an FFT (Fast Fourier Transform) mode and a guard interval mode and detecting the start point of a useful symbol so that a receiver can carry out an FFT operation.

### BACKGROUND ART

In a DVB-T (Digital Video Broadcasting-Terrestrial) system, a transmitter transmits desired information based on an IFFT (Inverse Fast Fourier Transform) operation over a predetermined frequency, and a receiver performs a demodulation operation by carrying out an FFT (Fast Fourier Transform) operation for received information. Thus, the receiver must recognize the start point of a data sample for which the FFT operation is carried out and sample duration of data for which the FFT operation is carried out so that a result of the accurate FFT operation can be produced. Symbols are classified according to a guard interval and useful data duration. In this case, since data of the guard interval corresponds to a copy of data associated with an end of the useful data duration, the FFT operation is carried out only for data of the useful data duration.

An FFT mode for DVB-T transmission includes to a 2K FFT mode based on 2,048 sub-carrier frequencies and an 8K FFT mode based on 8,192 sub-carrier frequencies. In order for ISI (Inter Symbol Interference) due to multiple paths to be reduced, one of guard intervals corresponding to 1/32, 1/16, ⅛ and ¼ of useful data duration associated with the FFT operation must be inserted. The transmitter selects one of the four guard intervals and transmits information of the selected guard interval.

After synchronization circuits provided in the receiver operate initially and normally, a TPS (Transmission Parameter Signalling) signal is detected so that information associated with a type of guard interval can be confirmed. However, the TPS signal cannot be detected at an initial receiver operation time. A type of FFT mode, a type of guard interval, guard interval information, etc. must be quickly and correctly detected. Using the type of guard interval and guard interval information, the FFT operation for data of the useful data duration is carried out.

To discriminate the FFT mode and the guard interval mode (or type), the conventional receiver uses a parallel structure in which sliding integrators and symbol integrators corresponding to the four guard intervals are provided as shown in FIG. 1.

FIG. 1 is a block diagram illustrating an apparatus for discriminating a guard interval in a conventional OFDM (Orthogonal Frequency Division Multiplexing) receiver.

Referring to FIG. 1, a length N-based correlating unit 100 makes a correlation between a currently received signal and a previously received signal corresponding to a previous symbol period in which a symbol is delayed, and outputs signals based on the correlation. The correlating unit 100 can include at least one symbol delay device and at least one correlator. If the symbol delay device delays one unit of symbol duration of the received signal and outputs information of the delayed symbol duration to the correlator, the correlator makes a correlation between a received signal before one unit of symbol duration and a received signal of the current symbol duration, and outputs signals based on the correlation. In other words, as the correlating unit 100 continuously makes the correlation between the received signal before one unit of symbol duration and the received signal of the current symbol duration, a value of the correlation between guard intervals increases and hence a peak signal between the guard intervals can be generated. Since the correlator carries out all processes for 2K/8K FFT sizes, a memory for N=8,192 bytes is required.

Sliding integrators 102a to 102d corresponding to guard intervals carry out a sliding operation associated with the length of each guard interval, accumulate correlation signals outputted from the correlating unit 100, and output the accumulated correlation signals, respectively. Symbol integrators 104a to 104d accumulate signals outputted from the sliding integrators 102a to 102d in units of symbols, respectively.

Maximum-value detectors 106a to 106d detect maximum values from among accumulated correlation values outputted from the symbol integrators 104a to 104d, and output the detected maximum values. The following guard-interval-mode discrimination unit 108 compares the detected maximum values of accumulated correlation values from the maximum-value detectors 106a to 106d, and selects the largest value from among the detected maximum values, such that the guard interval mode can be appropriately discriminated.

Since the largest value of accumulated correlation values associated with the four types of guard intervals must be detected in order for the system to discriminate a guard interval mode, a significant time is taken to discriminate the guard interval mode. After the accumulated correlation values associated with a guard interval corresponding to ¼ of the useful data duration are completely detected, the accumulated correlation values are compared and the largest value of the accumulated correlation values can be detected.

In order for the system to discriminate a guard interval mode, memories are required to implement integrators for the guard interval modes. Two memories are required to process a complex signal. Consequently, a memory capable of storing a total of 97,280 bytes is required.

### DISCLOSURE OF THE INVENTION

Therefore, the present invention has been made in view of the above problem, and it is one object of the present invention to provide an apparatus and method for performing an initial symbol synchronization and detection operation, which can quickly discriminate an FFT (Fast Fourier Transform) mode and a guard interval mode, and minimize the size of a memory necessary for discriminating the guard interval mode.

It is another object of the present invention to provide an apparatus and method for performing an initial symbol synchronization and detection operation, which can detect the start point of a useful symbol using location information associated with a maximum value of accumulated correlation values quickly detected.

It is yet another object of the present invention to provide an apparatus and method for performing an initial symbol synchronization and detection operation, which can improve reliability upon discriminating a guard interval mode and detecting the start point of a useful symbol.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an apparatus for discriminating a guard interval in a conventional OFDM (orthogonal Frequency Division Multiplexing) receiver;

FIG. 2 is a schematic view illustrating the outputs of sliding integrators with respect to input signals of guard intervals;

FIG. 3 is a block diagram illustrating an apparatus for performing an initial symbol synchronization and detection operation in accordance with an embodiment of the present invention;

FIG. 4 is an exemplary view illustrating signal distribution associated with a discrimination parameter D necessary for discriminating a guard interval mode in accordance with the embodiment of the present invention;

FIG. 5 is a block diagram illustrating an apparatus for performing an initial symbol synchronization and detection operation in accordance with another embodiment of the present invention;

FIG. 6 is an exemplary view illustrating the outputs of accumulated correlation values on a path-by-path basis in the apparatus for performing the initial symbol synchronization and detection operation shown in FIG. 5;

FIG. 7 is an exemplary view illustrating channel responses and accumulated correlation values associated with a pre-arriving path and a post-arriving path for an SFN (Single Frequency Network) channel;

FIG. 8 is an exemplary view illustrating ISI (Inter Symbol Interference) where the start point of a guard interval is set between the pre-arriving path and the post-arriving path; and

FIG. 9 is an exemplary view illustrating an operation of preventing the ISI where the start point of a guard interval is set before the pre-arriving path in accordance with the embodiment of the present invention.

### BEST MODE FOR CARRYING OUT THE INVENTION

In accordance with an embodiment of the present invention, the above and other objects can be accomplished by the provision of an apparatus for performing an initial symbol synchronization and detection operation in an OFDM (Orthogonal Frequency Division Multiplexing) receiver, the OFDM receiver including a correlator for making a correlation between a currently received signal and a previously received signal and outputting a result of the correlation, a sliding integrator for accumulating output signals of the correlator during a set guard interval and outputting a result of the accumulation, and a symbol integrator for accumulating output signals of the sliding integrator and outputting a result of the accumulation, said apparatus comprising:
a maximum-value detector for outputting a maximum-value detection signal when detecting a maximum value of accumulated correlation values from one of the integrators, and for selectively outputting a maximum value of accumulated correlation values from the other integrator;
a maximum-value position detector for outputting a count value currently counted by an internal counter as information associated with maximum-value position detection in response to the maximum-value detection signal; and
a guard-interval-mode discrimination unit for periodically comparing the count value outputted from the maximum-value position detector and a previous count value, producing a difference value between maximum-value positions, accumulating difference values during a predetermined time, producing an average value of the difference values, comparing the average value with a predetermined guard-interval discrimination parameter, and discriminating a guard interval mode and an FFT (Fast Fourier Transform) mode according to a result of the comparison.

In accordance with another embodiment of the present invention, there is provided a method for performing an initial symbol synchronization and detection operation so that a guard interval and useful data duration are discriminated from a modulated signal based on OFDM (Orthogonal Frequency Division Multiplexing) and an FFT (Fast Fourier Transform) operation is carried out, said method comprising the steps of:
detecting a position in which an output value of a sliding integrator is maximal from a path of an observation guard interval selected from a plurality of guard intervals;
comparing a value of the position in which the output value of the sliding integrator is maximal with a previous maximum-value position every counting period, producing a difference value between maximum-value positions, accumulating difference values during a predetermined time, producing an average value of the difference values, comparing the average value with a predetermined guard-interval discrimination parameter for the observation guard interval, and discriminating a guard interval mode and an FFT (Fast Fourier Transform) mode according to a result of the comparison; and
detecting a position in which an accumulated correlation value is maximal from a path of a discriminated guard interval, adding a value of discriminated guard interval length to a value of the detected position to produce an addition value, and outputting the addition value as information associated with a start point of a useful symbol.

Now, preferred embodiments of the present invention will be described in detail with reference to the annexed drawings so that those skilled in the art can easily understand the present invention.

The present invention is characterized in that a guard interval mode can be detected using only one sliding integrator. It is preferable that the sliding integrator associated with a guard interval corresponding to 1/32 of useful data duration is used in terms of the length of a guard interval. The principle capable of detecting an FFT (Fast Fourier Transform) mode and a guard interval mode using the one sliding integrator will be described with reference to the analysis of a received OFDM (Orthogonal Frequency Division Multiplexing) signal.

First, assuming that data loaded on a 1^{st} sub-carrier corresponding to an n^{th} OFDM reception symbol is r_{n,l} a correlation C_{n,l} between a signal time-delayed by an FFT size and a conjugate complex signal is expressed as in the following Equation 1.
C_{n,l}=r_{n,l}*r_{n,l-N} Equation 1

If a sliding integrator including a shift resistor and a subtracter corresponding to the length N_{g} of a guard interval accumulates outputs of a complex multiplier, a random parameter S_{n,l} can be expressed as in the following Equation 2.

$${S}_{n , l} = \frac{1}{N} {\sum }_{k = 0}^{{N}_{g}} {C}_{n , l + k} \qquad Equation 2$$

As shown in the above Equation 2, S_{n,l} has a maximum value when a guard interval value is multiplied by a signal value corresponding to a guard interval signal. If the length N_{g} is the same as the guard interval length of an input signal, a period equal to an OFDM symbol period T is repeated in relation to S_{n,l}. Otherwise, a maximum-value position associated with different lengths is variable. However, a maximum peak value is present within a symbol period according to self-correlation characteristics associated with the guard interval.

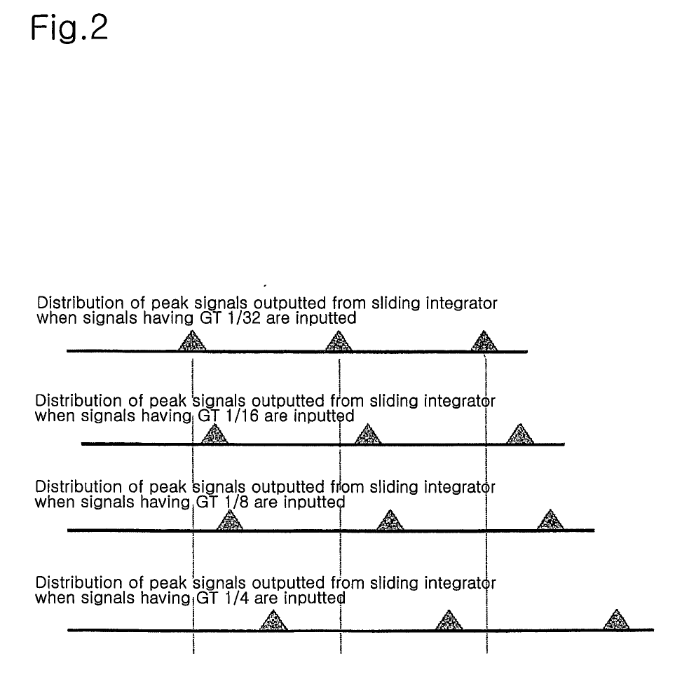

For reference, FIG. 2 is a schematic view illustrating outputs of sliding integrators with respect to input signals of guard intervals. It can be seen that a position of the maximum value of accumulated correlation values is different according to a guard interval of each input signal when a guard interval corresponding to 1/32 of useful data duration is used as an observation guard interval as shown in FIG. 2. In other words, if a period of the input signal having the guard interval length N_{g} matches a period of an observation guard interval (N+N_{g(1/32)}) in the receiver, the positions of maximum values periodically are the same in relation to symbols. On the other hand, if the guard interval length of the input signal is longer than the observation guard interval, a position of the maximum value is shifted by (N−N_{g(1/32)}) When a guard interval length for the input signal shown in FIG. 2 is ( 1/32) N, positions of the maximum value have the same periods. Alternatively, when the lengths of guard intervals are ( 1/16) N, (⅛) N and (¼) N, the guard intervals have predetermined offsets and are shifted.

An observation is conducted during an OFDM symbol period (N+N_{g(1/32)}) of a guard interval 1/32, and an index Iₙ corresponding to the maximum value of S_{n,l} shown in the above Equation 2 is obtained by the following Equation 3.
Iₙ=Maxₗ(S_{n,l}), 0≦l≦N+N/32 Equation 3

Further, a difference dₙ between the index Iₙ obtained by the above Equation 3 and a previous symbol index is produced by the following Equation 4. Furthermore, difference values between symbol indexes produced by the following Equation 4 are accumulated during a sufficient time N_{c} as in the following Equation 5, and a discrimination parameter D can be produced after the interference of noise is cancelled out and an average value of the difference values is produced. Thus, a guard interval mode can be discriminated using the discrimination parameter D.
dₙ=mod_{N+N}_{g(1/32)}(Iₙ₊₁−Iₙ) Equation 4

$$D = \frac{1}{{N}_{c}} {\sum }_{i = 1}^{{N}_{c}} {d}_{i} \qquad Equation 5$$

For reference, the discrimination parameter D is shown according to a guard interval of the received signal in the following Table 1. Values shown in the following Table 1 are associated with output value data of a correlator in the case where only a sliding integrator corresponding to the guard interval 1/32 is adopted. As apparent from the following Table 1, guard interval lengths are different and hence a difference between discrimination parameter values is large where an input signal is based on the 8K FFT mode.

TABLE 1

| | Type of guard | |
|---|---|---|
| | interval of | Discrimination |
| FFT mode | input signal | parameter D |
| 2K | 1/32 | 0 |
| | 1/16 | 64 |
| | 1/8 | 192 |
| | 1/4 | 448 |
| 8K | 1/32 | 0 |
| | 1/16 | 256 |
| | 1/8 | 768 |
| | 1/4 | 1792 |

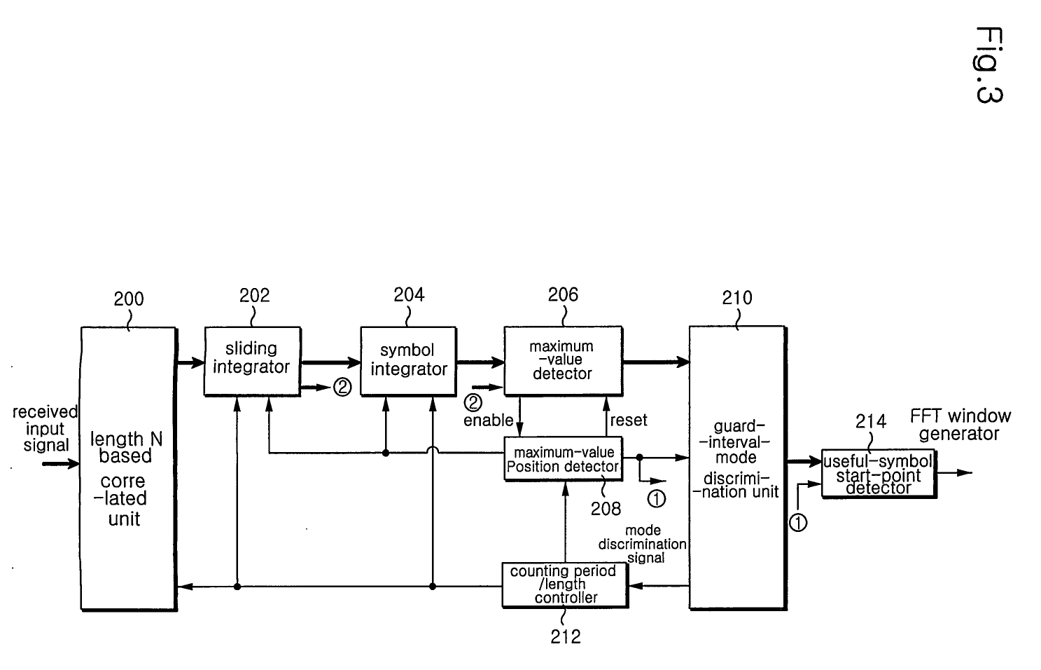

An initial symbol synchronization and detection apparatus designed on the basis of an analysis of the received OFDM signal is shown in FIG. 3.

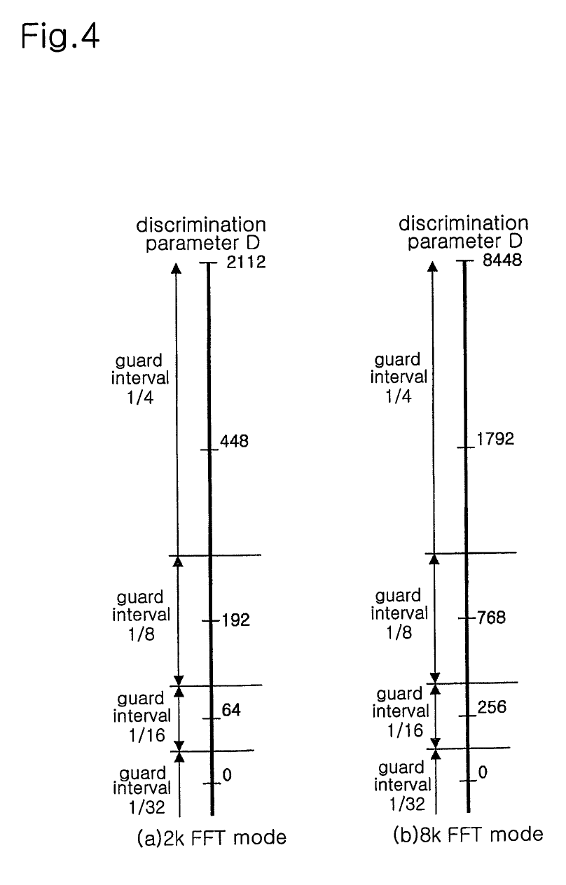

FIG. 3 is a view illustrating an apparatus for performing an initial symbol synchronization and detection operation in accordance with an embodiment of the present invention; and FIG. 4 is an exemplary view illustrating signal distribution associated with a discrimination parameter D necessary for discriminating a guard interval mode in accordance with the embodiment of the present invention.

In FIG. 3, a length N-based correlator 200 carries out a complex multiplication (or correlation) operation for a signal delayed by a set FFT size and a conjugate complex signal, and outputs a result of the complex multiplication operation. Here, the length N is adjusted in response to a length adjustment signal.

Initially, a sliding integrator 202 based on the length of 64 samples (2048/32) accumulates an output signal of the correlator 200 every 64 samples, and outputs a result of the accumulation. The sliding integrator 202 is reset in response to a carry signal outputted from a counter provided in a maximum-value position detector 208 described below, and its length is variably set in response to the length adjustment signal.

In an operating mode for discriminating an initial guard interval mode, the maximum-value position detector 208 outputs a maximum-value detection signal or enable signal when the maximum value of accumulated correlation values is detected within a period of the counter. A maximum-value detector 206 is reset in response to a carry signal outputted from a counter. The maximum-value detection signal is used as index information necessary for detecting the start point of a useful symbol. The reason why the output of the sliding integrator is used in the initial discrimination mode is because a guard interval mode cannot be discriminated in the initial time and hence data length for the symbol integrator cannot be appropriately set in the initial time.

The maximum-value position detector 208 includes an internal counter capable of counting 2K and 8K FFT modes and all periods of guard intervals. A counting period of the counter varies with a counting period adjustment signal described below. On the other hand, the maximum-value position detector 208 latches a count value of the internal counter when the maximum-value detection signal is inputted from the maximum-value detector 206, and outputs the latched value. The outputted latched count value indicates a position of the detected maximum value of accumulated correlation values, and corresponds to index information. For reference, the counter sets a counting period so that a 2K FFT mode and a guard interval 1/32 period (i.e., 2122(N+N/32) where N=2048) can be counted. A counting period/length controller 212 variably sets a counting period so that discriminated FFT mode and guard interval periods can be counted after discriminating the guard interval mode.

A symbol integrator 204 accumulates outputs of the sliding integrator 202 in units of symbols, and outputs a result of the accumulation.

On the other hand, a guard-interval-mode discrimination unit 210 periodically compares a count value outputted from the maximum-value position detector 208 and a previous count value in the initial guard interval discrimination mode (referred to as an initialization mode such as a power-on mode or a reset mode), and produces a difference value between positions of the maximum values according to a result of the comparison. Difference values are accumulated during a sufficient time N_{c}, the interference of noise is cancelled out and an average value of the difference values is produced. Here, it is preferable that N_{c} denoting a counting period of a reliable counter according to the above Equation 5 is set to a period of 8 symbols. The average value is compared to a discrimination parameter D for discriminating a guard interval mode. In other words, the guard-interval-mode discrimination unit 210 determines whether an average value produced by the guard-interval-mode discrimination unit 210 is present within a threshold range of discrimination parameters D classified according to a guard interval of the FFT mode. According to a result of the determination, the FFT mode and guard-interval-mode discrimination signals (referred to as mode discrimination signals) are outputted to a useful-symbol start-point detector 214 and the counting period/length controller 212. To discriminate the guard interval mode, the guard-interval-mode discrimination unit 210 includes an internal memory for storing values within a predetermined threshold range on a guard interval-by-interval basis according to the FFT mode. For reference, a value of the discrimination parameter D for discriminating a guard interval is shown in the above Table 1. If a sufficient margin is set as shown in FIG. 4 in terms of the influence of signal distortion and a sampling frequency error, a variable channel can be effectively processed.

After the guard interval discrimination mode, the useful-symbol start-point detector 214 adds a maximum-value position detection index inputted from the maximum-value position detector 208 to the length of the discriminated guard interval, and outputs a useful-symbol start-point detection signal. An FFT window generator generates an FFT window signal in synchronization with the useful-symbol start-point detection signal.

Operation of the above-described apparatus for discriminating the guard interval mode will now be briefly described. The correlator 200 carries out a complex multiplication operation for an input signal received in the initial guard-interval discrimination mode and a signal delayed by a time of 2,048 samples, and outputs a result of the complex multiplication operation. The sliding integrator 202 for detecting the guard interval 1/32 accumulates output signals of the correlator 200 every 64 samples, and outputs a result of the accumulation. Then, upon detecting a maximum value of accumulated correlation values from among output signals of the sliding integrator 202, the maximum-value detector 206 outputs the maximum-value detection signal. The maximum-value position detector 208 outputs a count value corresponding to a detected maximum-value position. Thus, the guard-interval-mode discrimination unit 210 periodically compares the count value outputted from the maximum-value position detector 208 and a previous count value, and produces a difference value between positions of the maximum values. Difference values are accumulated during a predetermined time, and then an average value of the difference values is produced. The guard-interval-mode discrimination unit 210 searches the internal memory to determine what is a threshold range containing the average value so that the FFT mode and the guard interval mode can be discriminated.

In other words, since four types of guard intervals and an FFT mode can be discriminated using only output signals of the sliding integrator corresponding to the 2K FFT mode and the guard interval 1/32 on the basis of the guard-interval discrimination mode in accordance with the present invention, the guard interval mode can be quickly discriminated.

After completing the guard-interval-mode discrimination, data lengths and counting periods associated with the correlator 200, the integrators 202 and 204 and the maximum-value position detector 208 are set appropriately for the length of the discriminated guard interval, and an accumulation operation is carried out in symbol durations using the sliding integrator 202 and the integrator 204 based on an OFDM symbol length as shown in the following Equation 6.

$${P}_{i , l} = {\sum }_{k = 0}^{L - 1} {S}_{i - k , l} , L = N + {N}_{g} \qquad Equation 6$$

An index of the maximum value among accumulated values as in the following Equation 7 is searched for and a useful-symbol start point τ_{c} is detected when the searched index is added to the guard interval length. Thus, if an FFT window is generated at the useful-symbol start point, a normal FFT operation can be carried out.

$${τ}_{c} = [ arg {max}_{l} {p}_{i , l} ] + {N}_{g} \qquad Equation 7$$

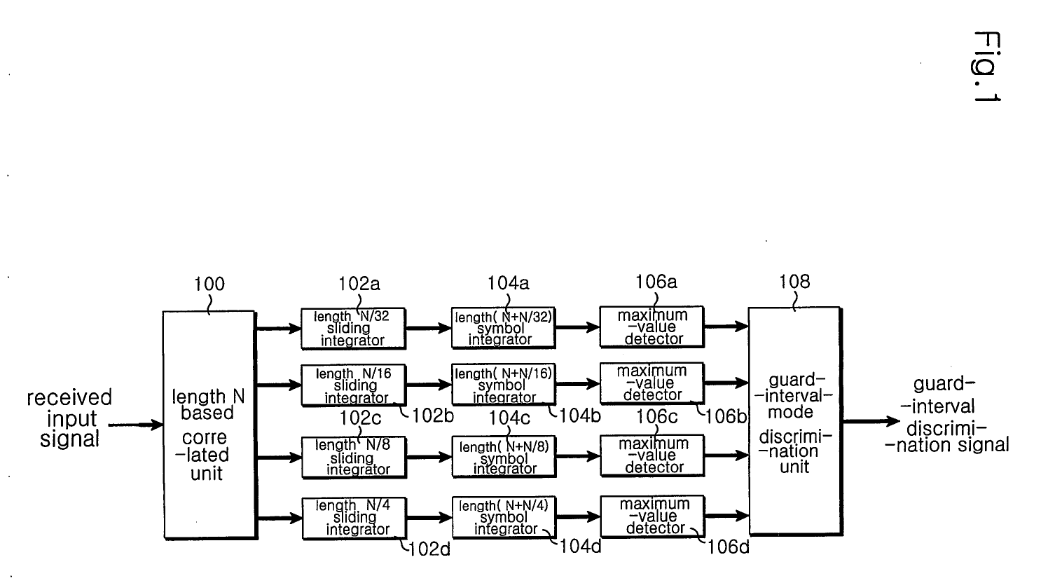

After the guard-interval-mode discrimination in accordance with the embodiment of the present invention, data lengths associated with the correlator and integrators are adjusted according to the discriminated guard interval mode. Furthermore, a counting period of the maximum-value position detector 208 is adjusted according to the discriminated FFT mode and guard interval mode, such that a position of the maximum value of accumulated correlation values associated with the discriminated guard interval mode can be detected. The length of a corresponding guard interval is added to the position of the maximum value of accumulated correlation values, such that the start point of a useful symbol can be detected. In accordance with the present invention, multiple integrators corresponding to guard interval paths are not needed. If only a memory having a size corresponding to the 8K FFT mode and the guard interval ¼ is provided in the present invention, a size of the memory can be relatively reduced as compared with FIG. 1.

Next, there will be described an apparatus and method for discriminating an FFT mode and a guard interval mode using all of sliding integrators and symbol integrators corresponding to four types of guard intervals and for detecting the start point of a useful symbol in accordance with another embodiment of the present invention.

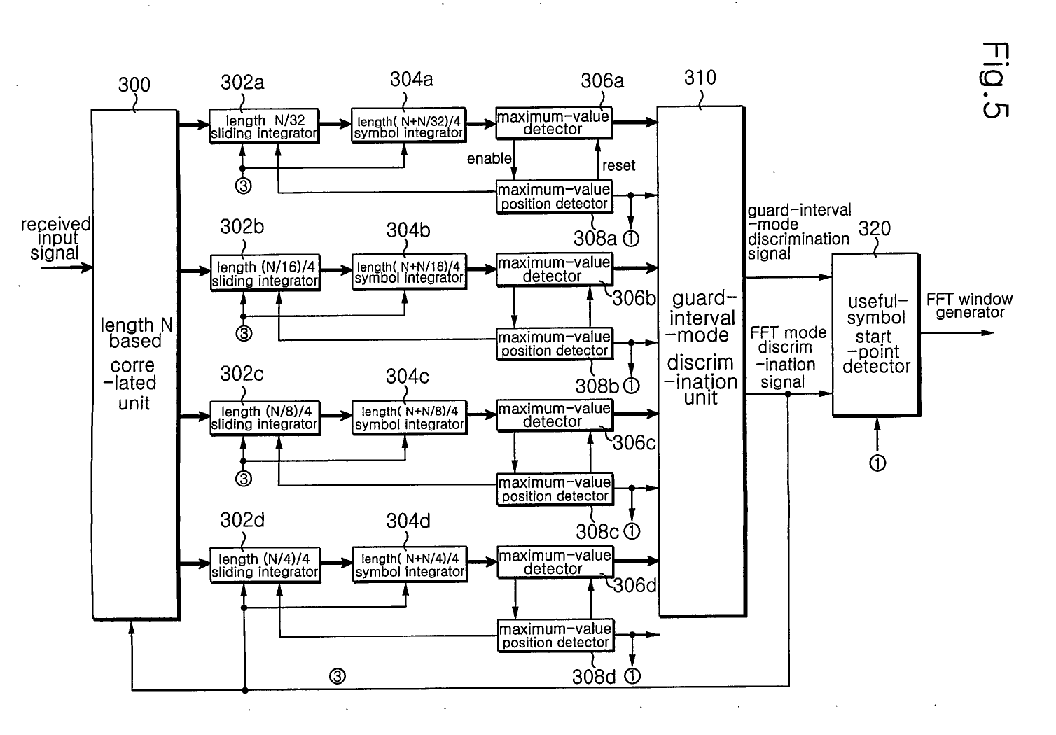

FIG. 5 is a block diagram illustrating an apparatus for performing an initial symbol synchronization and detection operation in accordance with another embodiment of the present invention. The apparatus can discriminate an FFT mode. There is a drawback in that the apparatus shown in FIG. 5 has a relatively complex hardware configuration in comparison with the apparatus shown in FIG. 3. However, the apparatus shown in FIG. 5 can reliably operate even at very low signal-to-noise ratios. In accordance with the present invention, the hardware complexity is reduced through a decimation operation based on a decimation order of 4. A maximum-value position detector is arranged at each path without adjusting its counter so that the start point of a useful symbol can be detected.

Referring to FIG. 5, a correlator 300 carries out a complex multiplication (or correlation) operation for a signal delayed by a predetermined FFT size and a conjugate complex signal, and outputs a result of the complex multiplication operation.

Sliding integrators 302a to 302d corresponding to guard intervals accumulate output signals of the correlator 300 corresponding to the number of samples whose lengths are adjusted according to an FFT mode, and outputs results of the accumulations. The sliding integrators 302a to 302d are reset in response to carry signals outputted from counters provided in maximum-value position detectors 308a to 308d.

Symbol integrators 304a to 304d corresponding to the sliding integrators 302a to 302d accumulate output signals of the sliding integrators 302a to 302d in unit of symbols, and output results of the accumulations.

Maximum-value detectors 306a to 306d output maximum-value detection signals or enable signals when maximum values are detected from among output signals of the symbol integrators 304a to 304d within counting periods of the counters. The maximum-value detectors 306a to 306d are reset in response to carry signals outputted from the counters.

The maximum-value position detectors 308a to 308d include internal counters capable of counting the discriminated FFT mode and guard interval period. When the maximum-value detection signals or enable signals are inputted from the maximum-value detectors 306a to 306d, count values of the internal counters are latched and the latched count values are outputted. The outputted latched count values correspond to maximum-value detection positions. The count values correspond to index information associated with maximum-value position detection. The index information \mathring{1} associated with the maximum-value position detection is inputted into a useful-symbol start-point detector 320.

A guard-interval-mode discrimination unit 310 discriminates an FFT mode and a guard interval mode. If a ratio of the first and second largest values among maximum values is equal to or larger than a threshold value, it is determined that the FFT mode is a 2K FFT mode. It is determined that a guard interval mode associated with a path having the first largest value is valid. An FFT mode discrimination signal and a guard-interval-mode discrimination signal are inputted into the useful-symbol start point detector 320 that detects the start point of a useful symbol. The data lengths associated with the correlator 300 and the integrators 302a to 302d and 304a to 304d can be adjusted according to an FFT mode discrimination signal \mathring{3}.

Operation of the guard-interval-mode discrimination apparatus will be briefly described.

Assuming that an input signal corresponds to the 2K FFT mode, initially, samples are accumulated according to a guard interval. According to this assumption, data length associated with a memory of the correlator 300 is adjusted so that the memory can store 512 bytes. Data lengths associated with the sliding integrator 302a and the symbol integrator 304a corresponding to the guard interval 1/32 path, are adjusted, such that the sliding integrator 302a accumulates 16 bytes and the symbol integrator 304a accumulates 64 bytes. In the 8K FFT mode, the sliding integrator 302a and the symbol integrator 304a accumulate 528 bytes and 2112 bytes, respectively. Data lengths associated with the sliding integrator 302b and the symbol integrator 304b corresponding to the guard interval 1/16 path are adjusted, such that the sliding integrator 302b and the symbol integrator 304b accumulate 32 bytes and 128 bytes in the initial 2K FFT mode, (or 1056 bytes and 2176 bytes in the 8K FFT mode), respectively. Data lengths associated with the sliding integrator 302c and the symbol integrator 304c corresponding to the guard interval ⅛ path are adjusted, such that the sliding integrator 302c and the symbol integrator 304c accumulate 64 bytes and 256 bytes in the initial 2K FFT mode (or 576 bytes and 2304 bytes in the 8K FFT mode), respectively. Data lengths associated with the sliding integrator 302d and the symbol integrator 304d corresponding to the guard interval ¼ path are adjusted, such that the sliding integrator 302d and the symbol integrator 304d accumulate 128 bytes and 512 bytes in the initial 2K FFT mode (or 640 bytes and 2560 bytes in the 8K FFT mode), respectively.

After the above-described adjustments are completed, accumulated correlation values are compared on the basis of symbols associated with the guard interval ¼ path since the length of symbols associated with the guard interval ¼ path is longest and a maximum value is detected from the accumulated correlation values. In other words, after n symbols associated with the guard interval ¼ path are completely accumulated, the guard-interval-mode discrimination unit 310 detects the first and second largest values from maximum values associated with output signals of the maximum-value detectors 306a to 306d. If a ratio of the first and second largest values is equal to or larger than a threshold value, it is determined that the FFT mode is the 2K FFT mode. It is determined that a guard interval mode associated with a path having the first largest value is valid.

In this case, symbols are continuously accumulated in relation to a selected path of the guard interval. It is preferable that operations of the remaining three paths are stopped so that hardware load can be reduced. On the other hand, if a ratio of the two detected values is smaller than the threshold value, it is determined that the FFT mode is the 8K FFT mode. According to the FFT mode discrimination, the data length associated with each integrator is adjusted and symbols corresponding to the adjusted length are accumulated in the integrator. Alternatively, if a ratio of the first and second largest values from maximum values is larger than the threshold value in the 8K FFT mode, it is determined that the FFT mode is the 8K FFT mode. It is determined that a guard interval mode associated with a path having the first largest value is valid. In this case, symbols associated with the path having the largest value are continuously accumulated. An accumulated correlation value is initialized every n symbols, and an accumulation operation is carried out.

According to the useful-symbol start-point detection operation described above, a position of the maximum value is detected as in the above Equation 7 and the length of a guard interval is added to the position of the maximum value, such that a start point τ_{c} of an FFT useful symbol is produced. The guard interval can be erroneously detected where the number of symbols between the maximum-value position of a current symbol and the maximum-value position of a previous symbol is large in relation to a maximum-value position of the guard interval selected to prevent an error. In this case, an initialization operation is carried out and the detection operation is again performed.

Steps of discriminating the FFT mode and the guard interval mode will now be described in order. The following steps are carried out in clockwise order when the FFT mode and the guard interval mode are discriminated.

\mathring{1} It is assumed that the FFT mode is the 2K FFT mode.

\hat{2} The correlator operates and sliding integration and symbol integration operations are carried out on a guard interval path-by-path basis.

\mathring{3} After n symbols are accumulated, maximum values are detected on the path-by-path basis and the detected maximum values are stored.

\mathring{4} The first largest value Peakₘₐₓ and the second largest value Peak_{2nd} are detected from the maximum values of accumulated correlation values after n-symbol duration associated with the guard interval ¼ path.

\mathring{5} A ratio of the two detected values is compared with a threshold value as in the following.

$$\frac{{Peak}_{max}}{{Peak}_{2 nd}} > γ , ( γ : threshold value )$$

\mathring{6} If the ratio of the two detected values is larger than the threshold value as a result of the comparison, the assumed FFT mode is maintained and it is determined that a path of the largest value corresponds to the guard interval.

\mathring{7} If the ratio of the two detected values is smaller than the threshold value as the result of the comparison, the FFT mode is switched to another mode other than the 2K FFT mode, the above steps \mathring{2} to \mathring{6} are carried out, and the FFT mode and the guard interval are discriminated.

\mathring{8} Operations associated with other paths except for a path associated with the determined guard interval are all stopped.

\mathring{9} In a path associated with the discriminated guard interval, a position when the guard interval length is added to the maximum-value position of one symbol is set as a start point of the useful symbol for which a FFT operation is carried out.

\mathring{10} A guard interval detection operation is initialized where a maximum-value position is continuously observed and a difference between the maximum-value position of a current symbol and the maximum-value position of a previous symbol corresponds to several consecutive symbols, and then the operation is restarted from the above step \mathring{1}.

Since the symbol integrators further accumulate output signals of the sliding integrators by symbol lengths corresponding to data lengths associated with counters, and the maximum value is detected after noise effect is reduced in accordance with another embodiment of the present invention, the reliability of guard interval detection can be assured more effectively in a very low signal-to-noise ratio environment as compared with the first embodiment of the present invention.

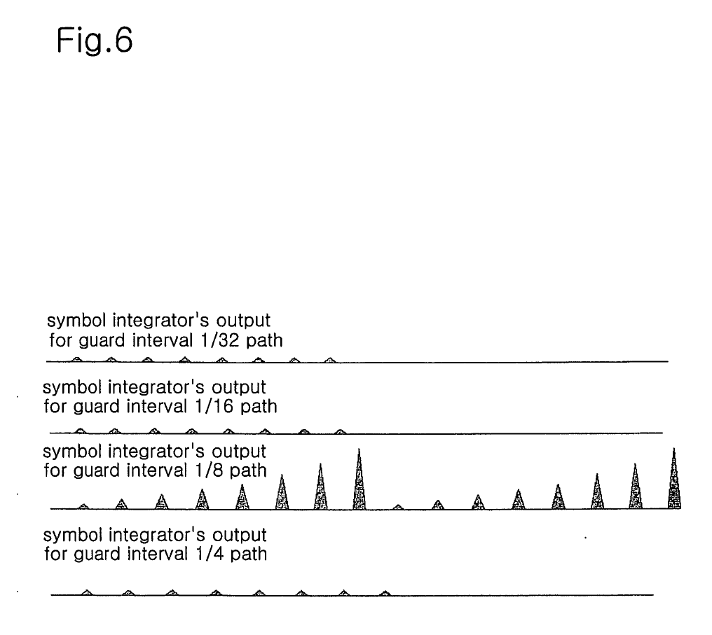

For reference, FIG. 6 shows a form representing outputs of accumulated correlation values on a path-by-path basis when an input signal corresponds to a guard interval ⅛ (i.e., n=8). In FIG. 6, an accumulated value associated with a guard interval ⅛ is largest. Since a value associated with the guard interval ⅛ path is largest when maximum values of accumulated correlation values are compared after 8 symbols, only the accumulation operation associated with the guard interval ⅛ is continuously carried out. Integrators associated with other paths do not perform the accumulation operations.

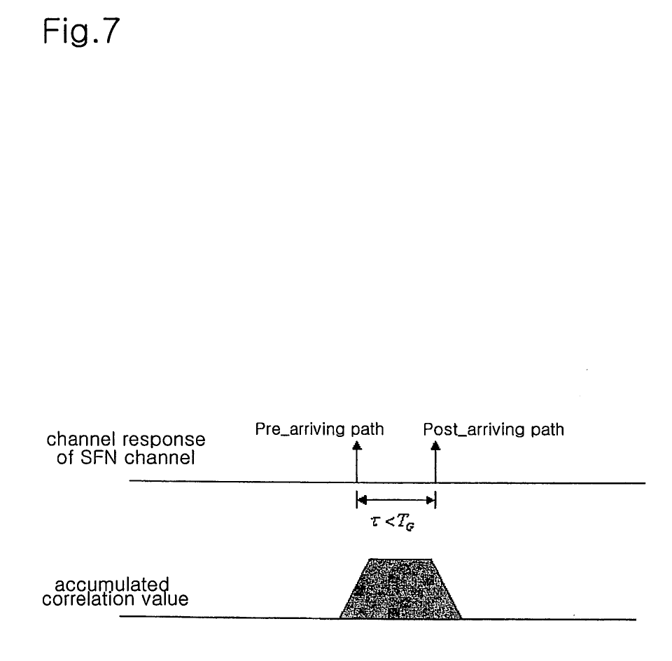

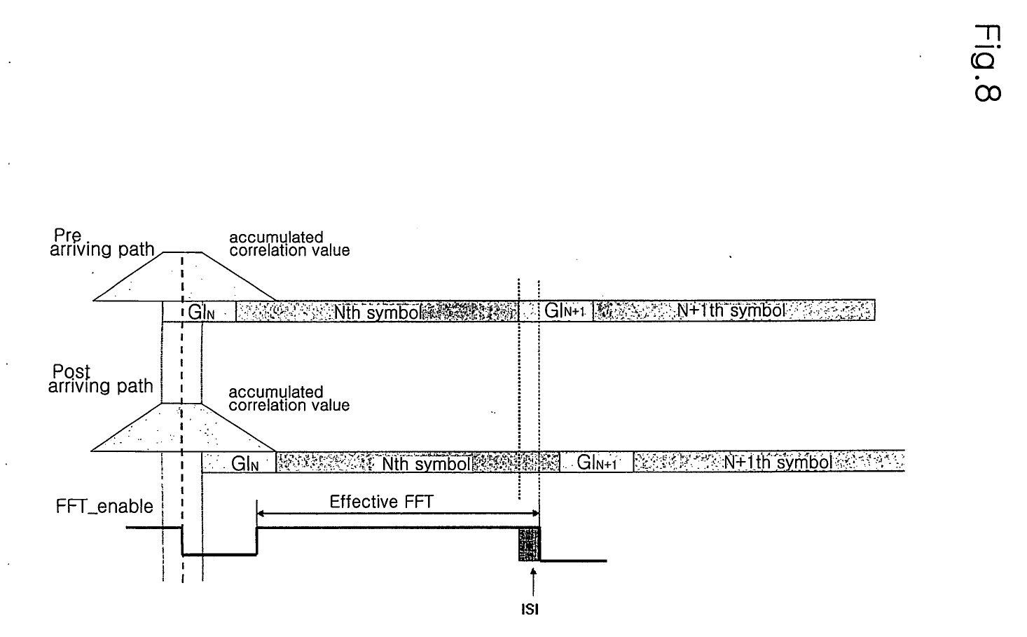

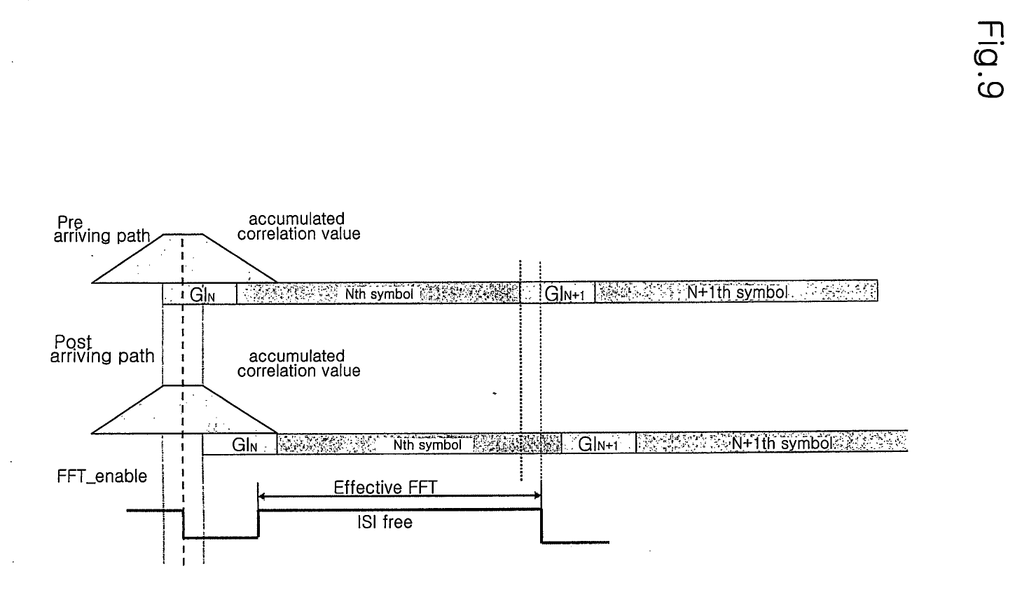

FIG. 7 is a view illustrating channel responses and accumulated correlation values associated with a pre-arriving path and a post-arriving path for an SFN (Single Frequency Network) channel; FIG. 8 is a view illustrating ISI (Inter Symbol Interference) where the start point of a guard interval is set between the pre-arriving path and the post-arriving path; and FIG. 9 is a view illustrating an operation of preventing the ISI where the start point of a guard interval is set before the pre-arriving path in accordance with the embodiment of the present invention.

As shown in FIG. 7, the SFN can be modeled so that two signals with almost identical electric powers can be located within a guard interval. A form of the accumulated correlation values has a trapezoid shape as shown in FIG. 7. Since a maximum-value detector for detecting an existing guard interval can detect a maximum value from among the accumulated correlation values, a center of the trapezoid form shown in FIG. 8 is determined to be a start point of the guard interval. The reason is that the center of the trapezoid form corresponds to a center of gravity. Where the start point of the guard interval is set as the center of the trapezoid form associated with the accumulated correlation values as shown in FIG. 8, the probability of ISI (Inter Symbol Interference) occurring in the latter part of an FFT window is high.

To reduce the probability of ISI occurring, the start point of the guard interval must be set on the basis of the pre-arriving path as shown in FIG. 9 so that the ISI in the latter part of the FFT window can be avoided. The present invention uses a principle of updating the maximum value only when a currently accumulated correlation value is larger than (1+k) times the previous maximum value where 0<k<0.5. The reason why a maximum-value position associated with the form of the accumulated correlation values for the SFN is set on the basis of the pre-arriving path is because an accumulated correlation value associated with a top flat part of the trapezoid form is not larger than (Accumulated Value for Pre-arriving Path*(1+k)) and hence the maximum-value position stays at a front part of the trapezoid form without being updated. An algorithm for implementing the present invention is shown in the following. A program or hardware can be designed so that a maximum-value detector performs the algorithm. For reference, Pi denotes an accumulated correlation value of an i^{th} sample in the above Equation 6.
max=0
for (i=0; i<N+Ng; i=i+1){
if (Pi>(1+k)*max)
max=Pi;
};
If the start point of the guard interval is set in relation to the pre-arriving path in the SFN channel using the algorithm, the ISI can be avoided as shown in FIG. 9 and hence the performance of a system can be enhanced.

### INDUSTRIAL APPLICABILITY

As apparent from the above description, the present invention can quickly discriminate a guard interval since an FFT (Fast Fourier Transform) mode and four types of guard intervals can be discriminated using only output signals of a sliding integrator corresponding to a 2K FFT mode and a guard interval 1/32 in an operation of discriminating the guard interval. As data length associated with the sliding integrator corresponding to the 2K FFT mode and the guard interval 1/32 is adjusted after the guard interval is discriminated, a useful-symbol start-point detection operation can be easily carried out. For this reason, a size of a memory can be significantly reduced using a sliding integrator and a symbol integrator corresponding to one guard interval path.

The present invention can easily detect the start point of a useful symbol by adding the length of a guard interval to a maximum-value position detected in a corresponding guard interval mode using information of the quickly discriminated guard interval mode. Furthermore, ISI (Inter Symbol Interference) can be avoided since the maximum-value position associated with a pre-arriving path is set as the detection point in an SFN (Single Frequency Network) channel.

Since the symbol integrators further accumulate output signals of the sliding integrators by symbol lengths corresponding to data lengths of reliable counters, and the maximum value is detected after noise effect is reduced in accordance with the present invention, the reliability of guard interval detection can be assured more effectively in a very low signal-to-noise ratio environment.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. An apparatus for performing an initial symbol synchronization and detection operation in an OFDM (Orthogonal Frequency Division Multiplexing) receiver, the OFDM receiver including a correlator for making a correlation between a currently received signal and a previously received signal and outputting a result of the correlation, a sliding integrator for accumulating output signals of the correlator during a set guard interval and outputting a result of the accumulation, and a symbol integrator for accumulating output signals of the sliding integrator and outputting a result of the accumulation, said apparatus comprising:
a maximum-value detector for outputting a maximum-value detection signal when detecting a maximum value of accumulated correlation values from one of the integrators, and for selectively outputting a maximum value of accumulated correlation values from the other integrator;
a maximum-value position detector for outputting a count value currently counted by an internal counter as information associated with maximum-value position detection in response to the maximum-value detection signal; and
a guard-interval-mode discrimination unit for periodically comparing the count value outputted from the maximum-value position detector and a previous count value, producing a difference value between maximum-value positions, accumulating difference values during a predetermined time, producing an average value of the difference values, comparing the average value with a predetermined guard-interval discrimination parameter, and discriminating a guard interval mode and an FFT (Fast Fourier Transform) mode according to a result of the comparison.

2. The apparatus as set forth in claim 1, further comprising:
a counting period/length controller for adjusting a counting period of the maximum-value position detector and data lengths associated with the correlator and the integrators in response to the discriminated FFT mode and guard interval mode; and
a useful-symbol start-point detector for adding a value of discriminated guard interval length to the count value outputted from the maximum-value position detector so that a start point of a useful symbol is detected.

3. The apparatus as set forth in claim 1, wherein data lengths associated with the correlator and the sliding integrator are set so that the correlator and the sliding integrator correspond to length of 2048 samples and length of 64 samples in an initial guard-interval discrimination mode, respectively, and wherein a counting period of the internal counter of the maximum-value position detector is set so that the internal counter of the maximum-value position detector periodically carries out a counting operation every 2048 samples.

4. The apparatus as set forth in claim 1, wherein the maximum-value detector allows a maximum-value position to be detected on the basis of a pre-arriving path in a form of accumulated correlation values for an SFN (Single Frequency Network).

5. An apparatus for performing an initial symbol synchronization and detection operation in an OFDM (Orthogonal Frequency Division Multiplexing) receiver, the OFDM receiver including a correlator for making a correlation between a currently received signal and a previously received signal of a previous symbol duration and outputting a result of the correlation, and sliding integrators, symbol integrators and maximum-value detectors outputting maximum values sequentially coupled to the correlator and associated with guard interval modes ( 1/32, 1/16, ⅛ and ¼) so that types of guard intervals for an OFDM signal are discriminated, said apparatus comprising:
maximum-value position detectors for outputting count values currently counted by internal counters as information associated with maximum-value position detection in response to maximum-value detection signals from the maximum-value detectors arranged on guard interval paths; and
a guard-interval-mode discrimination unit for comparing a ratio of first and second largest values among the maximum values outputted from the maximum-value position detectors arranged on the guard interval paths with a threshold value, discriminating an FFT (Fast Fourier Transform) mode, and determining that a guard interval mode corresponding to a guard interval path that outputs the first largest value is valid.

6. The apparatus as set forth in claim 5, further comprising:
a useful-symbol start-point detector for adding a value of discriminated guard interval length to a count value outputted from a maximum-value position detector so that a start point of a useful symbol is detected.

7. A method for performing an initial symbol synchronization and detection operation so that a guard interval and useful data duration are discriminated from a modulated signal based on OFDM (Orthogonal Frequency Division Multiplexing) and an FFT (Fast Fourier Transform) operation is carried out, said method comprising the steps of:
detecting a position in which an output value of a sliding integrator is maximal from a path of an observation guard interval selected from a plurality of guard intervals;
comparing a value of the position in which the output value of the sliding integrator is maximal with a previous maximum-value position every counting period, producing a difference value between maximum-value positions, accumulating difference values during a predetermined time, producing an average value of the difference values, comparing the average value with a predetermined guard-interval discrimination parameter for the observation guard interval, and discriminating a guard interval mode and an FFT (Fast Fourier Transform) mode according to a result of the comparison; and
detecting a position in which an accumulated correlation value is maximal from a path of a discriminated guard interval, adding a value of discriminated guard interval length to a value of the detected position to produce an addition value, and outputting the addition value as information associated with a start point of a useful symbol.

8. The method as set forth in claim 7, further comprising the step of:
variably setting the counting period according to the discriminated guard interval mode.

9. The method as set forth in claim 7, wherein the observation guard interval path is a path of a guard interval corresponding to 1/32 of the useful data duration.

10. A method for performing an initial symbol synchronization and detection operation so that a guard interval and useful data duration are discriminated from a modulated signal based on OFDM (Orthogonal Frequency Division Multiplexing) and an FFT (Fast Fourier Transform) operation is carried out, said method comprising the steps of:
detecting positions in which accumulated correlation values are maximum during a symbol period from a plurality of guard interval paths and detecting maximum values from the accumulated correlation values;
comparing a ratio of first and second largest values from the detected maximum values with a preset threshold value, discriminating an FFT (Fast Fourier Transform) mode, and determining that a guard interval mode corresponding to a guard interval path that outputs the first largest value is valid; and
detecting a position in which an accumulated correlation value is maximal from a path of a discriminated guard interval, adding a value of discriminated guard interval length to a value of the detected position to produce an addition value, and outputting the addition value as information associated with a start point of a useful symbol.

11. The apparatus as set forth in claim 2, wherein data lengths associated with the correlator and the sliding integrator are set so that the correlator and the sliding integrator correspond to length of 2048 samples and length of 64 samples in an initial guard-interval discrimination mode, respectively, and wherein a counting period of the internal counter of the maximum-value position detector is set so that the internal counter of the maximum-value position detector periodically carries out a counting operation every 2048 samples.

12. The apparatus as set forth in claim 2, wherein the maximum-value detector allows a maximum-value position to be detected on the basis of a pre-arriving path in a form of accumulated correlation values for an SFN (Single Frequency Network).

13. The method as set forth in claim 8, wherein the observation guard interval path is a path of a guard interval corresponding to 1/32 of the useful data duration.
